(19) United States
(12) Patent Application Publication
(10) Pub. No.: US 2008/0212958 A1
(43) Pub. Date: Sep. 4, 2008

(54) Protecting Apparatus for Small Image Photographing Devices

(75) Inventors: Jae-Young Park, Gyeonggi-do (KR); Sung-Youl Yun, Gyeonggi-do (KR); Chang-Soo Kim, Gyeongi-do (KR); Hyun-Jun Kang, Gyeonggi-do (KR)

Correspondence Address: HARNESS, DICKEY, & PIERCE, P.L.C, 7700 Bonhomme, Suite 400, ST. LOUIS, MO, 63105, US

(73) Assignee: M2SYS CO., LTD., Bucheon-si, Gyeonggi-do (KR)

(21) Appl. No.: 12/088,259

(22) PCT Filed: Apr. 25, 2007
(86) PCT No.: PCT/KR2007/002023

§ 371 Date: Mar. 27, 2008

(30) Foreign Application Priority Data
Apr. 26, 2006 (KR) 10-2006-0037864
Apr. 26, 2006 (KR) 10-2006-0037866
Dec. 29, 2006 (KR) 10-2006-0138327
Apr. 7, 2007 (KR) 10-2007-0034451
Apr. 7, 2007 (KR) 10-2007-0034452

(51) Int. Cl. G03B 17/00

(52) U.S. Cl. 396/448

(57) ABSTRACT

Disclosed herein is a camera protection apparatus for preventing foreign matters from entering a camera. The protection apparatus includes a shield frame installed frontward of the camera lens and having a sliding space for opening the front side of the lens. A blade is slidably installed in the sliding space to open and close front side of the lens. The blade is formed with a protrusion. A rotary lever is rotatably coupled with the shield frame. The rotary lever has a central opening formed at the rotational center thereof for opening the front side of the lens. The rotary lever has a cam groove formed so as to be engaged with the protrusion such that rotation of the rotary lever causes the protrusion to move to open and close the blade. The camera protection apparatus exposes the camera when it is to be used, and otherwise to close the camera opening. Thus, foreign matters can be prevented from entering the camera.

### TECHNICAL FIELD

The present invention relates to a protection apparatus for small cameras, more specifically to such protection apparatus, which is installed in the opening of a small camera so as to open the camera opening when it is to be used, and otherwise to close the camera opening, thereby efficiently preventing foreign matters from entering the camera.

### BACKGROUND ART

A small communications device such as cellular phones may be equipped with a small camera for taking a picture of a subject.

Such small cameras have employed a short-focal camera.

This short-focal camera includes multiple lenses for transmitting a subject image and an image sensor for processing the transmitted image, which are all integrated with the camera.

In case of such camera, all components are fixed inside of the case and shielded externally. Only the outmost lens is exposed to the outside.

Thus, dirt or the like tends to stick to the outmost lens so that the taken image can be blurred.

On the other hands, recently auto-focusing and zooming functions have been added to the small cameras according to the users' demand. In order to obtain quality images, the outmost lens must be cleaned.

In order to perform such auto-focusing and zooming, the lenses must be driven in a mechanical way to adjust the distances between the respective lenses and between the lens and the image sensor.

Accordingly, a sophisticated drive mechanism must be installed inside of the small functional camera, which therefore can not be closed from outside, dissimilar to the previous short-focal small camera.

Thus, foreign matters are introduced into the inside of the camera through the camera opening, through which light is transmitted. The introduced foreign matters degrade the performance of the camera driving components. In particular, if fine dusts stick to the image sensor, the image quality is extremely degraded, incomparably to the case where foreign matters stick to the lens. Furthermore, the dust stuck to the image sensor cannot be cleaned up to thereby lead to failure of the whole camera.

Therefore, there needs a device for blocking the foreign matters at the camera opening before entering the camera.

### DISCLOSURE OF INVENTION

### Technical Problem

The present invention has been made in order to solve at least part of the problems in the art. It is an object of the invention to provide a camera protection apparatus, which is installed in a small camera to open the camera opening when it is to be used, and otherwise to close the camera opening, thereby efficiently preventing foreign matters from entering the camera.

### Technical Solution

In order to accomplish the above objects, according to one aspect of the invention, there is provided a camera protection apparatus for preventing foreign matters from entering a camera, the protection apparatus being installed frontward of the lens of a small camera, the apparatus comprising: a shield frame being installed frontward of the camera lens and having a sliding space for opening front side of the lens; a blade having a protrusion, the blade sliding in the sliding space to open and close front side of the lens; and a rotary lever being rotatably coupled with the shield frame, the rotary lever having a central opening formed at the rotational center thereof for opening front side of the lens, the rotary lever having a cam groove formed so as to be engaged with the protrusion such that rotation of the rotary lever causes the protrusion to move to open and close the blade.

According to another aspect of the invention, there is provided a protection apparatus for a small camera, the apparatus comprising: a cover member fixed to a portable terminal, the cover member having an opening for opening a camera installed in the portable terminal and having an internal space; a blade slidably installed in the space to open and close the opening; and a slider lever slidably installed in the space to move the blade, wherein the slider lever is formed with a protrusion, and the blade is formed with a slant groove to be engaged with the protrusion such that when the slider lever performs a linear movement, the protrusion pushes the slant groove such that the blade moves perpendicular to the linear movement of the slider lever.

According to another aspect of the invention, there is provided a protection apparatus for a small camera, comprising: a front cover having a first opening formed for opening a camera installed in a portable terminal; a blade shaft-supported on the front cover to open and close the first opening through rotational movement thereof; a rotary lever for rotating the blade by means of rotational movement thereof; a guide frame for limiting rotational range of the blade and guiding the rotary lever to perform a smooth rotation; and a rear cover, together with the front cover, protecting both faces of the blade, the rotary lever and the guide frame, the rear cover having a second opening formed correspondingly to the first opening, the rear cover being combined to the portable terminal.

According to another aspect of the invention, there is provided a camera protection apparatus for a small camera, the apparatus comprising: a case member having an opening formed to expose a camera installed in a portable terminal, the case member having an internal space, the case member having a first retainer groove and a second retainer groove formed in the inner lateral face; a blade slidably installed in the internal space to open and close the opening; a rotary lever rotating in the internal space to operate the blade in a linear fashion, the rotary lever having a resilient protrusion that is selectively engaged with the first retainer groove or the second retainer groove such that the blade remains resiliently opened or closed.

According to another aspect of the invention, there is provided a protection apparatus for preventing foreign matters from entering a camera installed in a portable terminal, the apparatus being mounted frontward of the camera lens, the apparatus comprising: a shield plate installed in front of the camera lens and having a first opening for opening front side of the lens; a blade slidably opening and closing the first opening, the blade having a cam protrusion; a rotary plate rotatably combined with the shield plate, the rotary plate having a second opening formed at the rotational center thereof, the rotary plate having a cam hole formed to be engaged with the cam protrusion such that rotation of the rotary plate causes the cam protrusion to move so as to open and close the blade; a cover for combining the rotary plate rotatably into the shield plate, the cover having a third opening formed to be aligned with the second opening; a core fixed to either of the shield plate or the rotary plate; a coil wound around the core to make the core an electromagnet when an electric power is applied; a control unit for supplying an electric power to the coil; and a magnet fixed to either the shield plate or the rotary plate to which the core is not fixed, the magnet generating electromagnetic field towards the core.

According to another aspect of the invention, there is provided a protection apparatus for a small camera, the apparatus comprising: a cover member having an internal space, the cover member having an opening formed to shield and expose a camera installed in a portable terminal, the cover member being to be fixed to the portable terminal; a blade slidably mounted inside of the cover member so as to open and close the opening; and a spring disposed in the internal space so as to link the blade and the cover member to each other, wherein the blade is semi-automatically opened and closed by means of the spring.

According to another aspect of the invention, there is provided a protection apparatus for a small camera, comprising: a cover member having an internal space, the cover member having an opening formed to shield and expose a camera installed in a portable terminal, the cover member being to be fixed to the portable terminal; a blade slidably mounted inside of the cover member so as to open and close the opening; and a leaf spring mounted in the inner side of the cover member and contacting rear face of the blade, the leaf spring having at both sides a protrusion formed towards the blade.

### Advantageous Effects

The camera protection apparatus according to the invention is installed in a small camera such as cellular phone cameras to open the camera opening when it is to be used, and otherwise to close the camera opening. Thus, foreign matters can be prevented from entering the camera.

### BRIEF DESCRIPTION OF THE DRAWINGS

Further objects and advantages of the invention can be more fully understood from the following detailed description taken in conjunction with the accompanying drawings in which:

FIGS. 1 and 2 are exploded perspective views of a protection apparatus according to the first embodiment of the invention;

FIG. 3 shows the internal structure of the protection apparatus of FIG. 1;

FIGS. 4 and 5 are perspective views of the assembled protection apparatus of FIGS. 1 and 2;

FIG. 6 is a perspective view of a communications terminal according to the second embodiment of the invention;

FIGS. 7 and 8 are exploded perspective views of the protection apparatus in FIG. 6;

FIG. 9 is a perspective view showing the initial state of the protection apparatus of FIG. 6 when in use;

FIG. 10 is a perspective view of the protection apparatus of FIG. 9 when the blade is partially opened;

FIG. 11 is a perspective view of the protection apparatus of FIG. 10 when the blade is completely opened;

FIGS. 12 and 13 are exploded perspective views of a protection apparatus according to the third embodiment of the invention;

FIG. 14 is a perspective view showing operation of the protection apparatus of FIGS. 12 and 13;

FIG. 15 shows internal operations of the respective components in the protection apparatus of FIG. 14 when in use;

FIG. 16 is a perspective view of a protection apparatus and a communications terminal according to the fourth embodiment of the invention;

FIGS. 17 and 18 are exploded perspective views of the protection apparatus of FIG. 16;

FIGS. 19 and 20 show operation of the protection apparatus of FIGS. 17 and 18;

FIGS. 21 and 22 are exploded perspective views of a protection apparatus according to the fifth embodiment of the invention;

FIG. 23 is a sectional view of the protection apparatus of FIG. 21 where the core is attached to one magnet;

FIG. 24 is a partially enlarged view of FIG. 23;

FIG. 25 is a sectional view showing movement of the core in FIG. 23;

FIG. 26 is a partially enlarged view of FIG. 25;

FIG. 27 is a sectional view of the protection apparatus where the core is attached to the other magnet;

FIG. 28 is a partially enlarged view of FIG. 27;

FIGS. 29 and 30 are exploded perspective views of a camera protection apparatus according to the sixth embodiment of the invention;

FIG. 31 shows operations of the camera protection apparatus according to the sixth embodiment of the invention;

FIG. 32 shows internal operations in FIG. 31;

FIG. 33 shows the camera protection apparatus of sixth embodiment when mounted;

FIGS. 34 and 35 are exploded perspective views of a camera protection apparatus according to the seventh embodiment of the invention;

FIG. 36 shows operations of the camera protection apparatus according to the seventh embodiment of the invention;

FIG. 37 shows internal operations of FIG. 36; and

FIG. 38 is a perspective view of the camera protection apparatus when mounted.

### MODE FOR THE INVENTION

Hereafter, the first embodiment of the invention will be explained, with reference to the accompanying drawings.

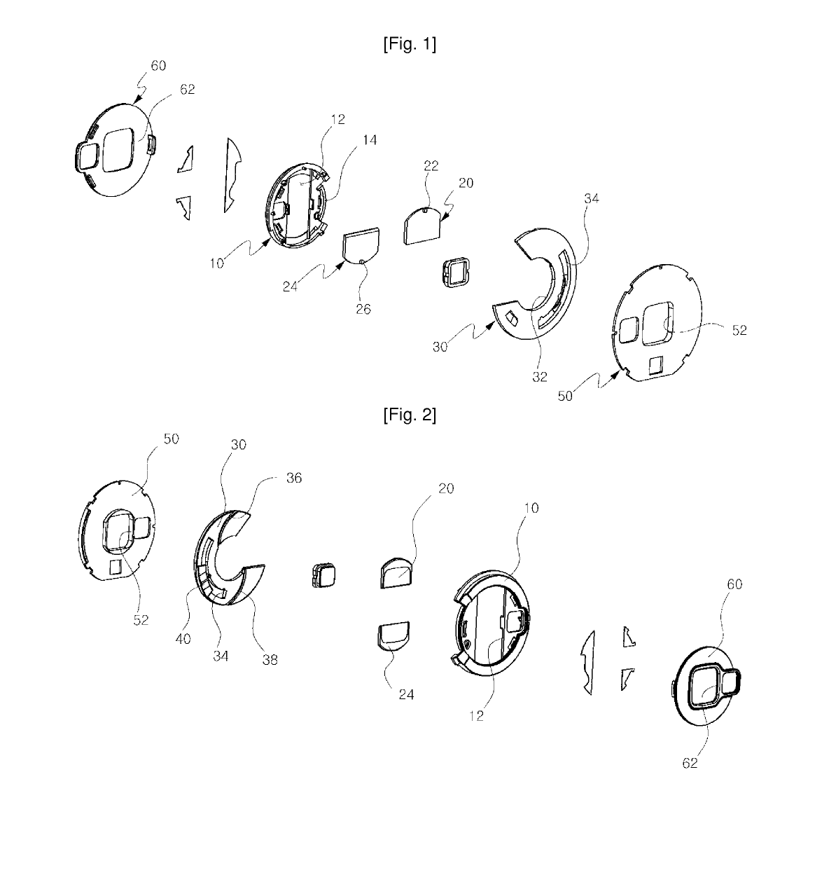

FIGS. 1 and 2 are exploded perspective views of a protection apparatus according to the first embodiment of the invention. FIG. 3 shows the internal structure of the protection apparatus.

The illustrated protection apparatus is installed in the front side of a small camera to prevent foreign matters from entering into the camera, i.e., serves as a camera protection apparatus.

This protection apparatus includes a shield frame 10 installed frontward of a camera lens. The shield frame 10 has a sliding space 12 for opening the front side of the lens. The protection apparatus includes a blade having a protrusion. The blade performs a sliding movement in the sliding space 12 to open and close the front side of the lens. A rotary lever 30 is rotatably combined to the shield frame 10. The rotary lever 30 is provided with a central opening 32 through which the front side of the lens can be opened. The rotary lever 30 has a cam groove formed to be engaged with the protrusion, such that rotation of the rotary lever 30 leads to movement of the protrusion to open and close the blade.

The blade is composed of a first blade 20 and a second blade 24 symmetrically disposed. The protrusion includes a first protrusion 22 formed in the first blade 20 and a second protrusion 26 formed in the second blade 24. The cam groove includes a first cam groove 36 engaged with the first protrusion 22 and a second cam groove 38 engaged with the second protrusion 26.

In this way, use of two blades results in an increase twice in the lens opening and closing speed. In addition, the size of each blade 20, 24 can be reduced in half and thus the blade can be installed in a limited space.

On the other hand, the rotary lever 30 is provided with a stopper groove 34, and the rotary lever 30 is provided with a guide rib 14 that is engaged with the stopper groove 34 to limit rotational angle of the rotary lever 30.

In addition, the rotary lever 30 is provided with a handle 40 protruded for a user to push it.

The protection apparatus includes a cover member for preventing the blade combined to the shield frame 10 from escaping.

The cover member is composed of a first cover 50 for preventing the rotary lever 30 from escaping from the upper side of the shield frame 10 and a second cover 60 for preventing the first and second blades 20 and 24 from escaping from the lower side of the shield frame 10. The first cover 50 and the second cover 60 are formed with a first opening 52 and a second opening 62 for opening the front side of the lens.

This protection apparatus may be installed frontward of a small camera that is mounted on a portable phone or the like, to thereby avoiding foreign matters from entering into the lens area.

Hereafter, operations of the above-configured protection apparatus are explained.

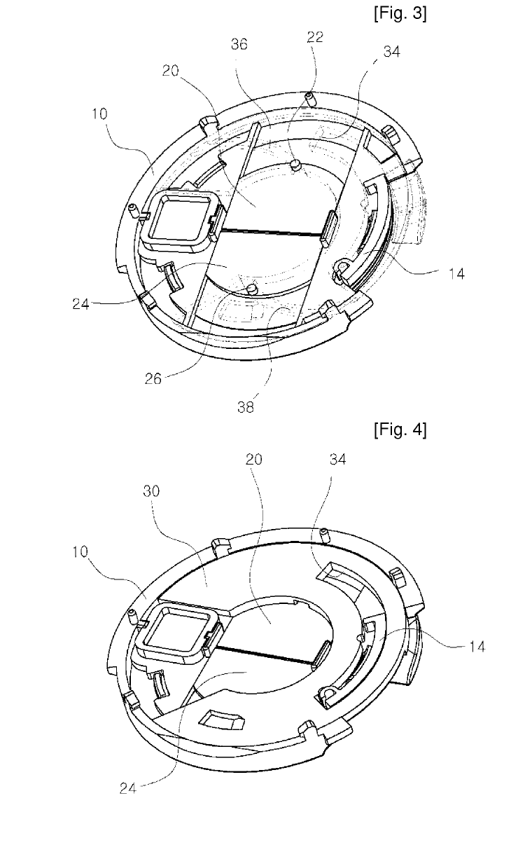

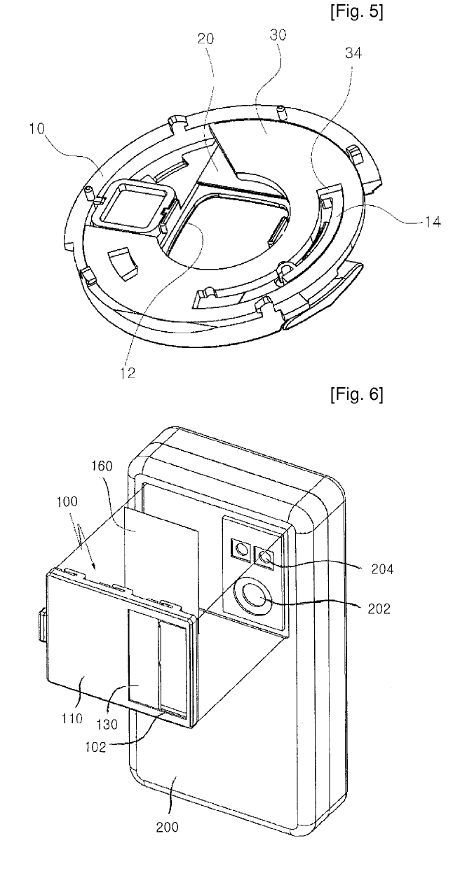

FIG. 4 is a perspective view of the protection apparatus when closed, and FIG. 5 is a perspective view of the protection apparatus when the blade is opened.

When not intended to photograph an image, the first and the second blades 20 and 24 are closed in front of the lens.

When using the camera, the protection apparatus mounted on the camera is to be opened. For this purpose, the user pushes the handle 40 of the rotary lever 30 using his or her finger. Then, as the rotary lever 30 rotates, the first and second cam grooves 36 and 38 cause the first and second protrusions 22 and 26 to move horizontally such that the first and second blades 20 and 24 become opened. Through the cam grooves 36 and 38, rotation of the rotary lever 30 is transferred into linear movement of the first and second blades 20 and 24.

Accordingly, the first and second blades 20 and 24 move far away from each other simultaneously in the sliding space 12 to thereby expose the lens. Light can enter the opened sliding space 12 to enable image-photographing.

On the other hand, when not using the camera, the user turns the handle 40 in reverse direction. Then, closing operation of the first and second blades 20 and 24 is carried out in the reverse orders to the above opening operations, to thereby close the lens.

In this way, if the sliding space 12 is closed, foreign matters are prevented from entering the inside of the small camera.

Hereafter, the second embodiment of the invention will be explained, with reference to the accompanying drawings.

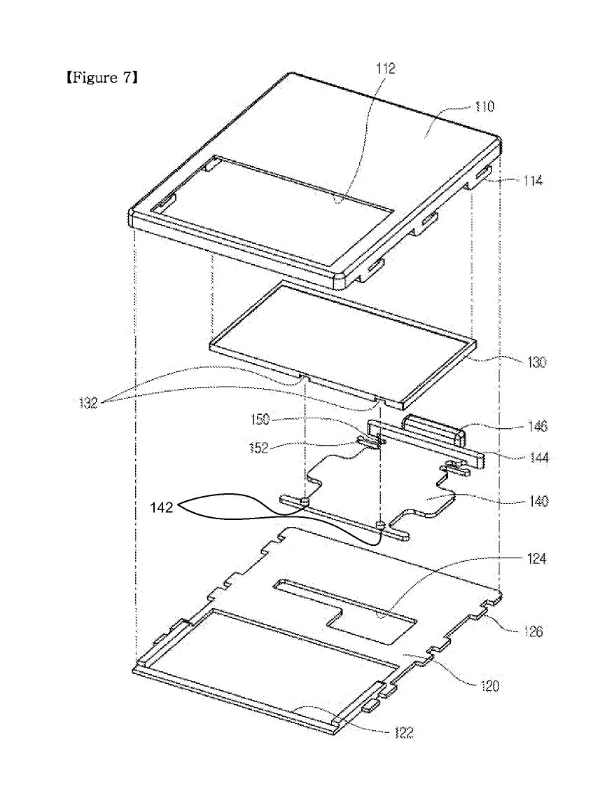

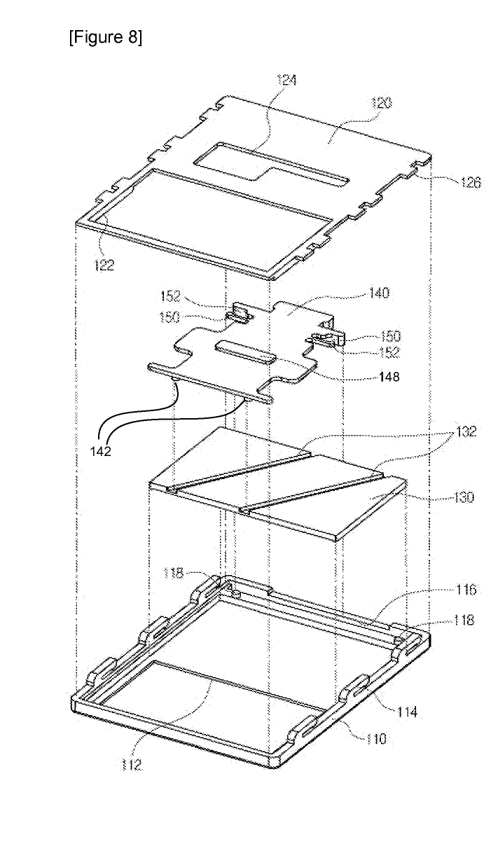

FIG. 6 is a perspective view of a communications terminal according to the second embodiment of the invention. FIGS. 7 and 8 are exploded perspective views of the protection apparatus in FIG. 6.

In this embodiment, the protection apparatus 100 includes a cover member to be fixed to a portable terminal 220. The cover member has an opening for exposing a camera 202 installed in the portable terminal 200 and an internal space formed thereinside. A blade 130 is slidably installed in the internal space so as to open and close the opening. A slider lever 140 is slidably installed in the internal space so as to operate the blade 130.

The cover member is composed of a front cover 110 having a first opening formed therein and a rear cover 120 having a second opening 122 formed correspondingly to the first opening 112. A plurality of first coupling ribs 114 is formed in the front cover 110 and the rear cover 110 is provided with a plurality of second coupling ribs 126 formed so as to be engaged with the first coupling ribs 114. Formed between the front cover 110 and the rear cover 120 is the internal space in which the slider lever 140 and the blade 130 are installed.

The slider lever 140 is formed with a protrusion 142 and the blade 130 is formed with a slant groove 132 to be engaged with the protrusion 142. Thus, when the slider lever 140 performs a linear motion, the protrusion 142 pushes the slant groove 132 such that the blade 130 moves perpendicular to the movement of the slider lever 140. The slant groove 132 is inclined at an angle to the extent that the blade 130 can be smoothly moved by the protrusion 142.

Formed in one face of the slider lever 140 is a first guide rib 144. A second guide rib 148 is formed in the other face of the slider lever 140. Formed in the front cover 110 is a first guide groove for guiding the first guide rib 144 to perform a linear movement. Formed in the rear cover 120 is a second guide rib 148 for guiding the second guide rib 148 to perform a linear movement.

The slider lever 140 is provided with a handle 146 protruding to the outside of the cover member. For this purpose, the front cover 110 and the rear cover 120 provides an opening in-between.

The front cover 110 is provided with stopper protrusions 118 formed symmetrically at both lateral sides. The slider lever 140 is provided at its initial position with a depressed portion 150 formed so as to be engaged with the stopper protrusion 118, and at its moved position with a resilient rib 152 for resiliently grab the stopper protrusion 118.

The cover member may be fixed to the portable terminal 200 using a bonding means such as a double-sided adhesive tape 160. In addition, the cover member may be attached to the portable terminal 200 using a fastener means, a fusion bonding means or the like.

This protection apparatus 100 mounted on a portable terminal 200 prevents foreign matters from sticking to the camera 202 lens or entering inside of the camera 202.

Hereafter, operation of the above protection apparatus will be explained.

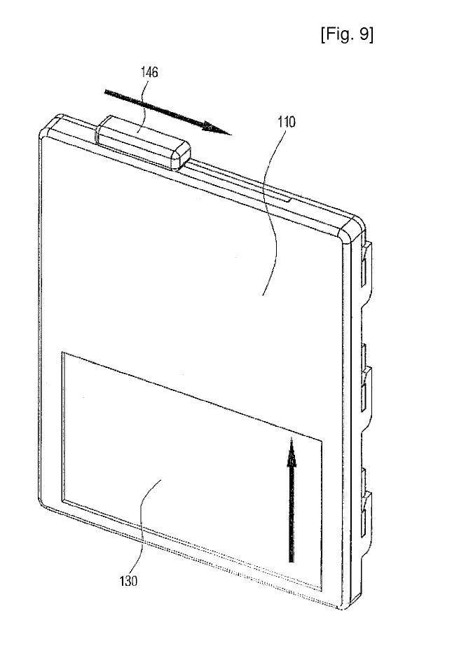

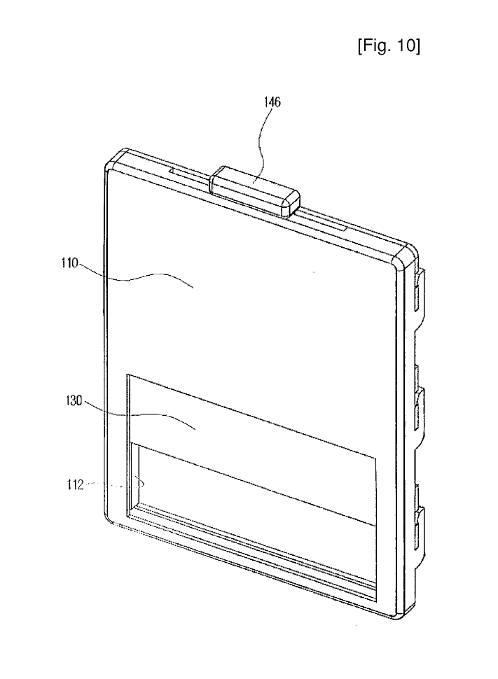

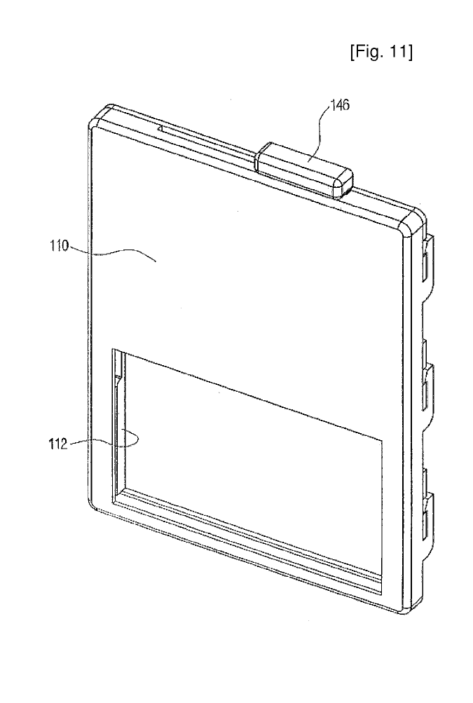

FIG. 9 is a perspective view showing the initial state of the protection apparatus of FIG. 6 when in use. FIG. 10 is a perspective view of the protection apparatus of FIG. 9 when the blade is partially opened. FIG. 11 is a perspective view of the protection apparatus of FIG. 10 when the blade is completely opened.

When the camera is not used, the blade 130 of the protection apparatus 100 shields between the first and second openings 112 and 122 and thus shields the camera 202 and flash 204 installed in the portable terminal 200. Thus, at this state the camera 292 cannot be used.

At this time, the stopper protrusion 118 of the front cover 110 is inserted into the depressed portion 150 and the resilient rib 152 presses them. Thus, the slider lever 140 and the blade 130 remain in place by means of a desired elastic retaining force.

On the other hand, in order to use the camera 202, the protection apparatus 100 mounted on the camera 202 is to be opened. For this purpose, if the user pushes the handle 146 to the right in FIG. 4, the slider lever 140 is moved to the right and the protrusion 142 pushed the slant groove 132.

Therefore, the blade 130 moves perpendicular to the slider lever 140 and, via the state shown in FIG. 10, the first and second openings 112 and 122 are completely opened, as shown in FIG. 11. Then, the camera 202 and the flash 204 are exposed and the camera 202 can be used.

At this time, the stopper protrusion 118 of the front cover 110 is inserted into the depressed portion 150 of the slider lever 140 and the resilient rib 152 presses them. Thus, the slider lever 140 and the blade 130 remain opened.

On the other hand, when the camera 202 is not used, if the handle 146 is moved in the opposite direction, the slider lever 140 and the blade 130 are moved in the opposite direction.

In this way, if the first and second openings 112 and 122 are closed, the camera 202 and the flash 204 are closed to prevent entering of the foreign matters.

Hereafter, the third embodiment of the invention will be explained, with reference to the accompanying drawings.

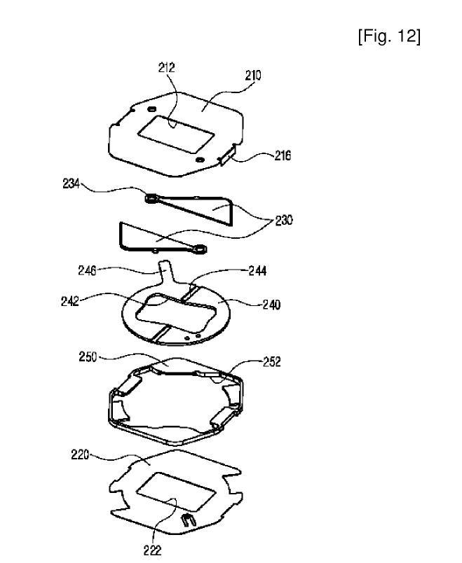

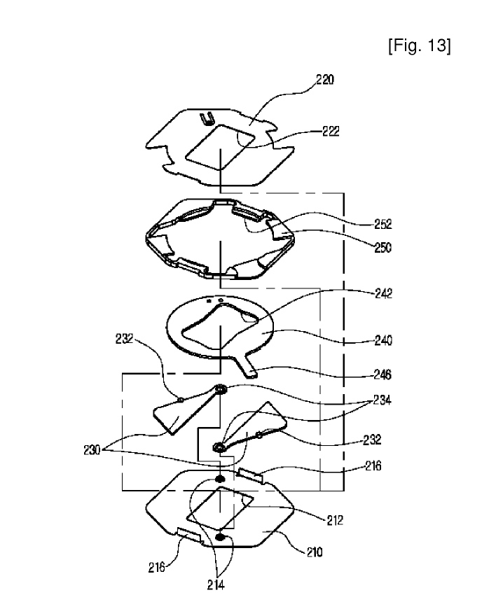

FIGS. 12 and 13 are exploded perspective views of a protection apparatus according to the third embodiment of the invention.

In this embodiment, the protection apparatus includes a front cover 210 having a first opening 212 formed to expose a camera installed in a portable terminal, a blade 230 rotatably supported on the front cover 210 such that it rotates to open and close the first opening 212, a rotary lever 240 being rotated to rotate the blade 230, a guide frame 250 limiting the rotational range of the blade 230 and guiding smooth rotation of the rotary lever 240, and a rear cover 220 to be attached to the portable terminal and having a second opening 222 corresponding to the first opening 212. The rear cover 220, together with the front cover 210, protects both faces of the blade 230, the rotary lever 240 and the guide frame 250.

Formed in the front cover 210 is a shaft 214. The blade 230 is provided with a rotation hole 234 formed so as to be rotatably engaged with the shaft 214.

The blade 230 is composed of a pair of pieces that symmetrically operates at the same time to open and close half of the first opening respectively. By using one pair of blades, opening and closing speed of the first opening 212 increases twice, as compared with a single piece of blade.

The blade 230 is formed with a cam protrusion 232. The rotary lever 240 is formed with a cam groove 244 being engaged with the cam protrusion 232 such that rotation of the rotary lever 240 is converted into pivot-motion of the blade 230 to open and close the first opening 212.

The rotary lever 240 is provided with a third opening formed correspondingly to the first opening 212. The rotary lever 240 is provided with a handle 246 protruding outwards.

Formed at one face of the front cover 210 or the rear cover 220 is a connection rib 216 for combining the remaining components.

The rear cover 220 may be fixed to the portable terminal using a bonding means such as a double-sided adhesive tape. In addition, the rear cover 220 may be attached to the portable terminal using a fastener means, a fusion bonding means or the like.

This protection apparatus mounted on a portable terminal prevents foreign matters from sticking to the camera lens or entering inside of the camera.

Hereafter, operation of the above protection apparatus will be explained.

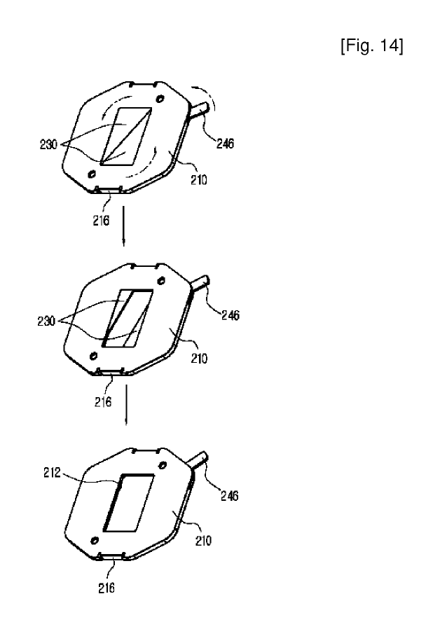

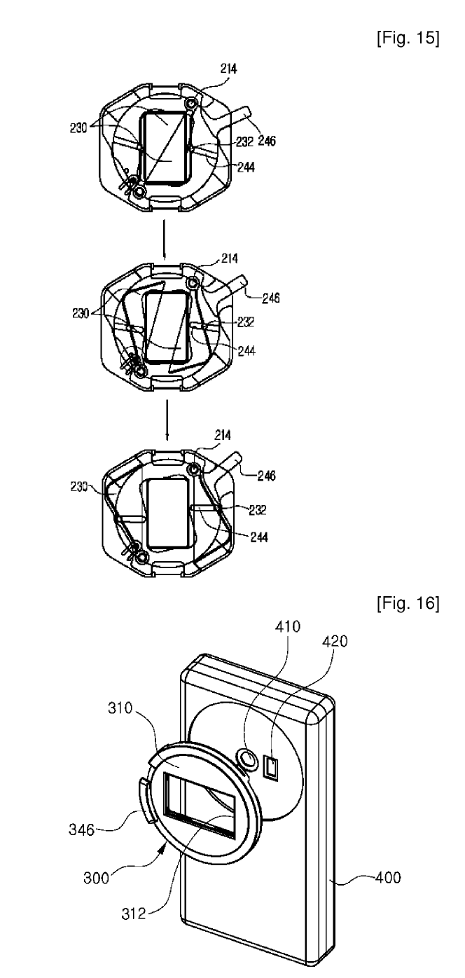

FIG. 14 is a perspective view showing operation of the protection apparatus of FIGS. 12 and 13. FIG. 15 shows internal operations of the respective components in the protection apparatus of FIG. 14 when in use.

When the camera is not being used, as shown in the first view of FIGS. 14 and 15, the blade 230 shields the first opening to close the camera installed in the potable terminal.

On the other hand, in order to use the camera, the protection apparatus is to be opened to expose the camera. For this purpose, if the user pushes the handle 246 to the left in FIG. 14 using a finger, the rotary lever 240 rotates to the left (counterclockwise) and the cam protrusion 232 pushes the cam groove 244 of the blade 230.

Then, the blade 230 completely opens the first opening 212, as shown in the third view of FIGS. 14 and 15, via the state shown in the second view thereof. Thus, the camera becomes exposed to enable to use it.

At this time, the inner side face of the guide frame 250 restricts the blade 230 not to be overly rotated, and also guides smooth rotation of the rotary lever 240.

On the other hand, when the camera is not used, the user moves the handle 246 in reverse direction so that the rotary lever 240 and the blade 230 move in reverse direction.

In this way, if the first opening 212 is closed, the camera is closed to prevent introduction of foreign matters.

Hereafter, the fourth embodiment of the invention will be explained, with reference to the accompanying drawings.

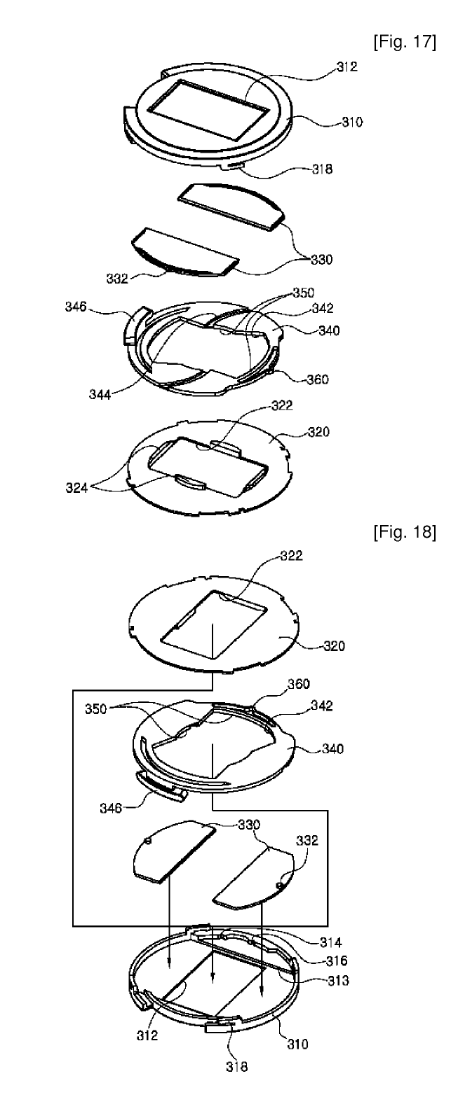

FIG. 16 is a perspective view of a protection apparatus and a communications terminal according to the fourth embodiment of the invention. FIGS. 17 and 18 are exploded perspective views of the protection apparatus of FIG. 16.

The protection apparatus 300 of this embodiment includes a case member having an opening formed so as to expose a camera 410 installed in a portable terminal 400. The case member has an internal space, and a first retainer groove 314 and a second retainer groove 316 formed in the inner side face thereof. The protection apparatus includes a blade 330 slidably operating in the space to open and close the opening. Further, the protection apparatus 300 includes a rotary lever 340 rotatably operating in the space so as to move the blade in a linear fashion. The rotary lever 340 has a resilient protrusion 360 that is selectively engaged with the first retainer groove 314 or the second retainer groove 316 such that the blade 330 can be held in place resiliently in the open or closed state.

The case member is composed of a front cover 310 having a first opening 312 formed to expose to the camera 410, and a rear cover 320 having a second opening 322 formed correspondingly to the first opening 312. The front cover 320 is combined with the rear cover 320 by means of multiple connection ribs 318.

The front cover 310 has a guide face 313 formed so as to guide the blade 330 to carry out a smooth linear movement.

The blade 330 is composed of a pair of pieces that symmetrically operates at the same time to open and close half of the first opening respectively. By using one pair of blades 330, opening and closing speed of the first opening 312 increases twice, as compared with a single piece of blade.

The blade 330 is formed with a cam protrusion 332, and the rotary lever 340 is formed with a cam groove 344 being engaged with the cam protrusion 332 such that rotation of the rotary lever 340 can be transferred into a linear motion of the blade 330.

The rotary lever 340 is provided with a handle 346 protruding outwards of the case member.

The rotary lever 340 is formed with a round face 350. The rear cover 320 is formed with a guide rib 324 contacting the round face 350 to guide the rotary lever 340 to perform a smooth rotation.

The rear cover 320 may be fixed to the portable terminal 400 using a bonding means such as a double-sided adhesive tape. In addition, the rear cover 320 may be attached to the portable terminal 400 using a fastener means, a fusion bonding means or the like.

This protection apparatus 300 mounted on a portable terminal 400 prevents foreign matters from sticking to the camera 410 lens and the flash 420 or entering inside of the camera 410.

Hereafter, operation of the above protection apparatus will be explained.

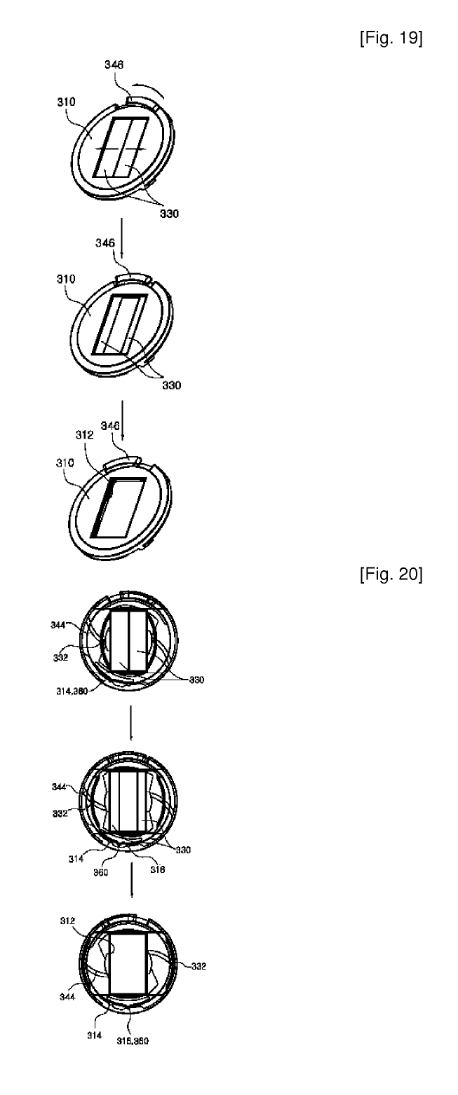

FIGS. 19 and 20 show operation of the protection apparatus of FIGS. 17 and 18.

When the camera 410 is not being used, the blade 330 shields the first opening 312 to close the camera 410 installed in the portable terminal 400 as shown in the first view of FIGS. 19 and 20.

At this time, the resilient protrusion 360 of the rotary lever 340 is engaged with the first retainer groove 314 such that a desired elastic force restricts rotation of the rotary lever 340. Thus, the first opening 312 remains closed by the blade 330.

On the other hand, in order to use the camera 410, the protection apparatus is to be opened to expose the camera 410. For this purpose, if a user pushes the handle 346 to the left in FIG. 19, the rotary lever 340 rotates to the left and the cam protrusion 332 pushes the cam groove 344 of the blade 330.

Therefore, the blade 330 becomes completely opened as shown in the third view of FIGS. 19 and 20, via the second view thereof. Thus, the camera 410 and the flash 420 are exposed, enabling use of it.

At this time, the guide face 313 of the front cover 310 guides later side of the blade 330 so as to enable smooth and linear movement of the blade 330. In addition, the guide rib 324 of the rear cover 320 contacts the round face 350 of the rotary lever 340 to allow for smooth rotation of the rotary lever 340.

In addition, the resilient protrusion 360 of the rotary lever 340 is engaged with the second retainer groove 316 of the front cover 316 such that a desired elastic force restricts rotation of the rotary lever 340. Thus, the first opening 312 remains opened by the blade 330.

On the other hand, when the camera 410 is not used, the handle 346 is pushed back in reverse direction and then the rotary lever 340 and the blade 330 are moved in revere direction.

In this way, if the first opening 312 is closed, the camera 410 is closed to prevent introduction of foreign matters.

Hereafter, the fifth embodiment of the invention will be explained, with reference to the accompanying drawings.

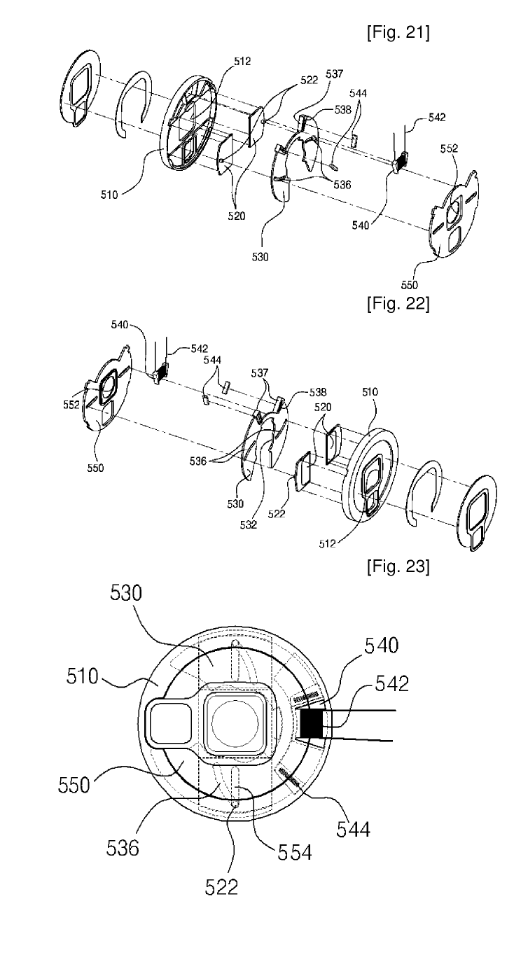

FIGS. 21 and 22 are exploded perspective views of a protection apparatus according to the fifth embodiment of the invention.

The protection apparatus of this embodiment is installed frontward of the lens of a small camera in order to prevent foreign matters from entering the camera.

This camera protection apparatus includes a shield plate 510 to be installed frontward of the camera lens and having a first opening for opening the front side of the lens. The protection apparatus includes a blade 520 that slidably operates to open and close the first opening 512 and has a cam protrusion 522. A rotation plate 530 is rotatably combined with the shield plate 510. The rotation plate 530 has a second opening formed at its rotational center to open the front side of lens. The rotation plate 530 has a cam hole 536 formed to be engaged with the cam protrusion 522 such that rotation of the rotation plate 530 incurs opening and closing of the blade 520. The protection apparatus includes a cover 550 for combining the rotation plate 530 rotatably to the shield plate 510. The cover 550 has a third opening 552 formed correspondingly to the second opening 532. A core 540 is fixed to the shield plate 510. A coil 542 is wound around the core 540. The core 540 and the coil 542 form an electromagnet when electric power is applied thereto. A control unit is provided to supply the electric power to the coil 542. A magnet 544 is fixed to the rotation plate 530. The magnet 544 generates electromagnetic field towards the core 540.

The blade 520 is installed in pairs in symmetrical positions. The cam protrusion 522 and the cam hole 536 forms a pair.

In this way, use of two blades 520 results in an increase twice in the lens opening and closing speed. In addition, the size of each blade 520 can be reduced in half and thus the blade can be installed in a limited space.

The cover 550 is provided with a guide hole 554 formed to guide the cam protrusion 522 to move in a linear fashion.

The magnet 544 is disposed in pairs at both sides of the core 540. Thus, each magnet 544 is allowed to move until it contacts the lateral side of the core 540, thereby limiting rotation angle of the rotation plate 530.

The magnets 544 are disposed such that same polarities face each other. Since the core 540 has different polarities at both ends thereof, one of the magnets exerts an attractive force and the other one thereof exerts a repulsive force. Thus, rotational force exerted on the rotation plate 530 becomes doubled.

The rotation plate 530 is provided with a cut-out portion 537 formed to have a space where the core 540 moves both direction. Formed at both edge areas of the cut-out portion 537 is an insert hole 538 into which the magnet 544 is inserted.

This protection apparatus is installed frontward of a small camera, which is mounted on a portable terminal or the like, to prevent foreign matters from entering the lens region.

The control unit for applying electric power to the coil 542 is installed inside of the main body of the portable terminal.

Hereafter, operation of the above protection apparatus will be explained.

When photographing is not required, the front side of the lens is closed by the pair of blades 520 in the protection apparatus.

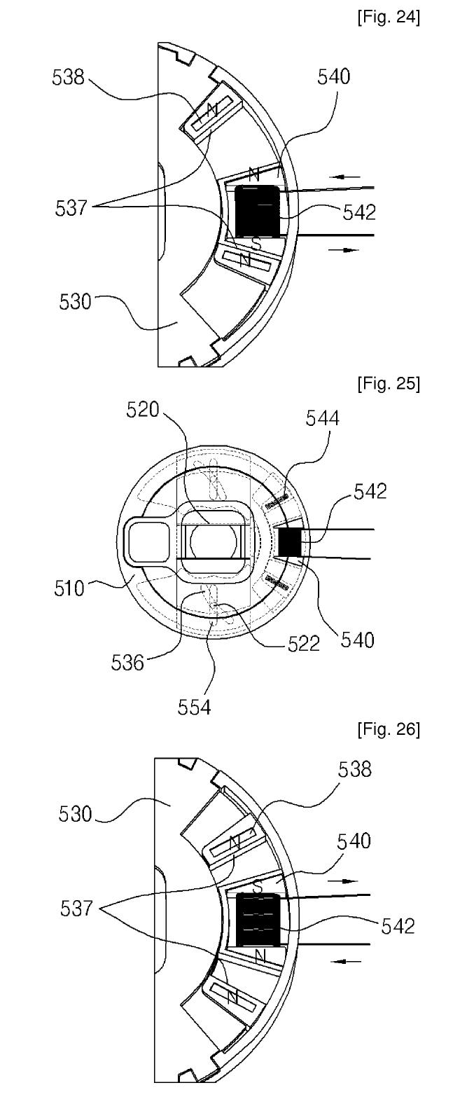

FIG. 23 is a sectional view of the protection apparatus of FIG. 21 where the core is attached to one magnet. FIG. 24 is a partially enlarged view of FIG. 23.

In order to use the camera, the protection apparatus mounted on the camera is to be opened. For this purpose, the control unit applies electric power to the coil 542 to magnetize the core 540.

FIG. 25 is a sectional view showing movement of the core in FIG. 23. FIG. 26 is a partially enlarged view of FIG. 25.

If the core 540 is magnetized, one end of the core becomes an N-pole and the other end thereof becomes an S-pole. If both magnets are disposed such that their N-poles are towards the core 540, the magnet 544 placed frontward of the S-pole of the core 540 draws the core 540 and the other magnet 544 repels the core 540.

Thus, the rotation plate 530 comes to rotate. Then, the cam hole 536 drives the cam protrusion 522 in the horizontal direction to move the blade 520 in the opening direction. The cam hole 536 converts rotation of the rotation plate 530 into a linear motion of the blade 520. The guide hole 554 of the cover 550 guides the cam protrusion 522 to enable to perform a linear movement.

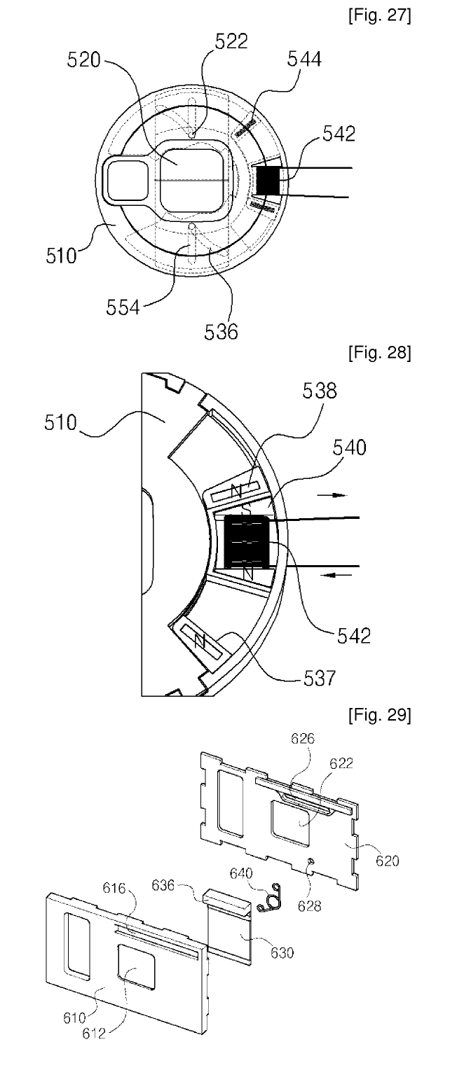

FIG. 27 is a sectional view of the protection apparatus where the core is attached to the other magnet. FIG. 28 is a partially enlarged view of FIG. 27.

A pair of blades 520 moves far away from each other at the same time to open the first opening 512 to expose the lens. Light enters the camera lens through the opened camera lens, thereby allowing the camera to take a picture.

On the other hand, when the camera is not being used, the control unit reverses the electric current being applied to the coil 542. Thus, the polarities of the core are switched with each other and then the other side magnet 544 is made to be attached to the core 540.

Therefore, the pair of blades 520 closes the lens in reverse orders to the above operations.

At this state, even if electric current is not applied to the coil, the core 540 remains attached to the magnet 544.

In this way, if the first opening 512 is closed to shield the camera, foreign matters are prevented from entering the camera mounted on a portable terminal.

Hereafter, the sixth embodiment of the invention will be explained, with reference to the accompanying drawings.

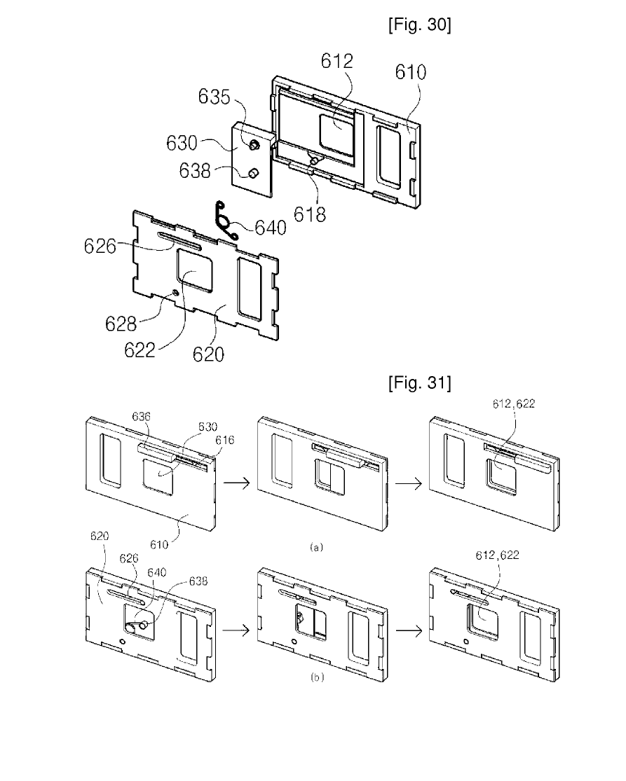

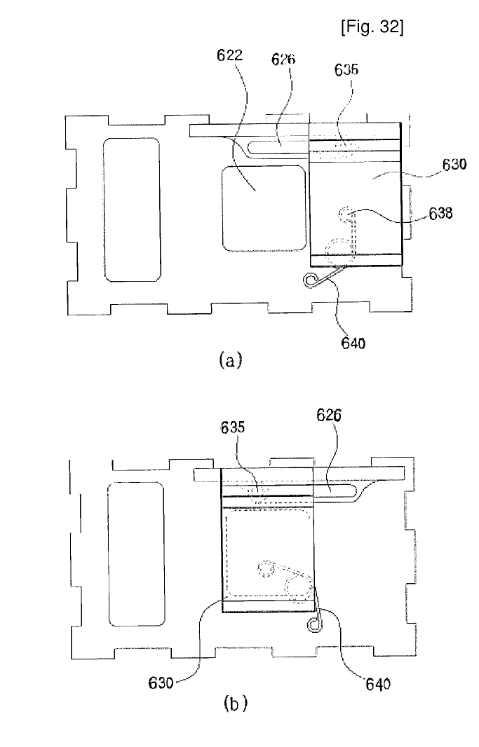

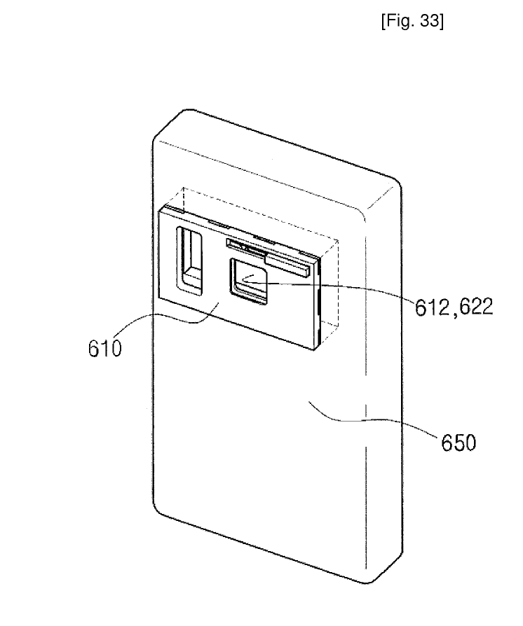

FIGS. 29 and 30 are exploded perspective views of a camera protection apparatus according to the sixth embodiment of the invention. FIG. 31 shows operations of the camera protection apparatus according to the sixth embodiment of the invention. FIG. 32 shows internal operations in FIG. 31. FIG. 33 shows the camera protection apparatus of sixth embodiment when mounted.

Referring to FIGS. 29 to 33, the camera protection apparatus of a portable terminal 650 includes a cover member, a blade 630 and a spring 640.

The cover member is installed in front of a camera mounted on a portable terminal 650. The cover member is provided with openings 612 and 622 for shielding and exposing the camera. The cover member is formed to have an internal space in which the blade 630 and the spring 640 are received.

The cover member may be formed of a single piece. Alternatively, for the purpose of easy fabrication and assembling, it is formed of two pieces of members to be combined with each other.

That is, as shown in FIGS. 29 and 30, the cover member is composed of a front cover 610 and a rear cover 620.

The front cover 610 and the rear cover 620 are provided with openings 612 and 622 respectively. The camera is disposed correspondingly to the openings 612 and 622.

The blade 630 is slidably mounted inside of the cover member so as to open and close the openings 612 and 622. Ultimately, the blade 630 opens and closes the openings 612 and 622 to shield and expose the camera.

The blade 630 is provided with a lever 636 formed to protrude towards the front cover 610. The front cover 610 is formed with a slot hole 616 through which the lever 636 passes.

As shown in FIG. 31, the blade 630 is configured such that the user can grab and slide the lever 636 along the slot hole 616.

FIGS. 31(a) and (b) show the opening operations of the openings 612 and 622 through movement of the 630, seen from the front cover 610 and the rear cover 620 respectively.

Inside of the cover member, i.e., in the internal space, is mounted the spring 640 connecting the blade 630 with the cover member.

The spring 640 is disposed between the blade 630 and the rear cover 620 in a way that one end of the spring is fixed to the cover member and the other end thereof is fixed to the blade 630.

For this purpose, the blade 630 and the front cover 610 are formed with support protrusions 618 and 638 respectively into which both ends of the spring 640 are inserted and fixed thereto. The rear cover 620 is formed with an insert hole 628 into which the support protrusion 618 formed in the front cover 610 is inserted.

Thus, between the blade 630 and the rear cover 620, one end of the spring 640 is inserted into the support protrusion 618 formed in the front cover 610. The other end thereof is inserted into and fixed to the support protrusion 638 formed in the rear face of the blade 630.

At this time, the length of the support protrusion 618, formed in the front cover 610, is made larger than the thickness of the blade 630. Thus, the other end of the spring 640 can be inserted and fixed from between the blade 630 and the rear cover 620.

In addition, the spring 640 is made in the form of ‘M’ or formed of a torsion spring.

In order for the blade 630 to slide inside of the cover member smoothly without wobbling, a guide protrusion 635 is formed in the blade 630. Formed in the inner side of the rear cover 620 is a guide hole 626 into to which the guide protrusion 635 is inserted and moves therein.

The guide hole 626 is closed at its both ends and thus serves as a stopper when the guide protrusion 635 slides.

FIG. 32(a) shows the openings 612 and 622 when opened, and FIG. 32(b) shows them when closed.

As shown in FIG. 32, the spring 640 is installed such that it becomes most relaxed when the blade 630 is opened or closed, rather then when it is moving.

That is, the spring 640 is disposed such that it's both ends become inclined when the blade 630 is opened or closed, in other words, the line being formed by the support protrusions 618 and 638, to which both ends of the spring 40 are fixed, becomes inclined.

Due to the above configuration, as shown in FIGS. 31 and 32(a), when the openings 612 and 622 of the cover member are opened, the upper end of the spring 640, i.e., the support protrusion 638 formed in the blade 630 is placed to be inclined to the right, relative to the support protrusion 618 formed in the front cover 610.

At this state, if the user pushes the lever 636 of the blade 630 to the left, the spring 640 is compressed until the imaginary line between the upper and lower ends of the spring 640 becomes perpendicular to the moving direction of the blade 630.

After passing this state, as shown in FIGS. 31(b) and 32(b), due to the restoring force of the spring 640, automatically the blade 630 continues to move to the right direction in the cover member to close the openings 612 and 622.

That is, as shown in FIG. 32(b), when the openings 612 and 622 of the cover member are closed, the upper end of the spring 640, i.e., the support protrusion 638 formed in the blade 630, becomes inclined to the left, relative to the support protrusion 618 formed in the front cover 610.

At this time, the guide protrusion 635 formed in the blade 630 moves along the guide hole 626 of the cover member and then is stopped by contacting the closed ends of the guide hole 626.

In order to open the openings 612 and 622, the lever 636 is to be moved in the opposite direction to the above operation.

With the camera protection apparatus of this embodiment, after the openings are opened roughly halfway, the rest thereof can be automatically opened due to the resiliency of the spring 640, thereby enabling semi-automatic opening and closing of the openings 612 and 622.

Thus, since the camera installed in the portable terminal 650 is opened only when it is to be used, foreign matters are prevented from sticking to the camera lens or entering inside of the camera.

Hereafter, the seventh embodiment of the invention will be explained, with reference to the accompanying drawings.

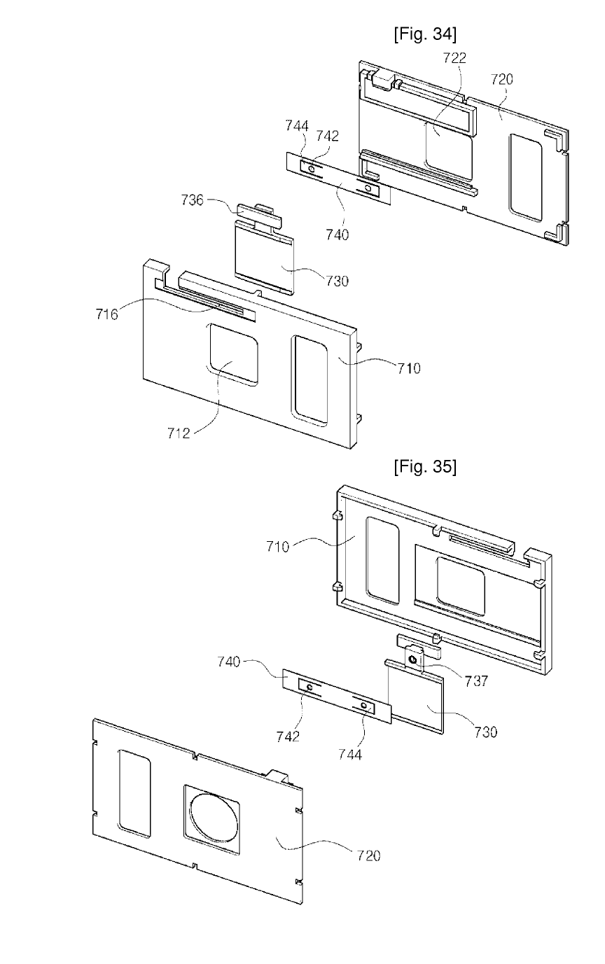

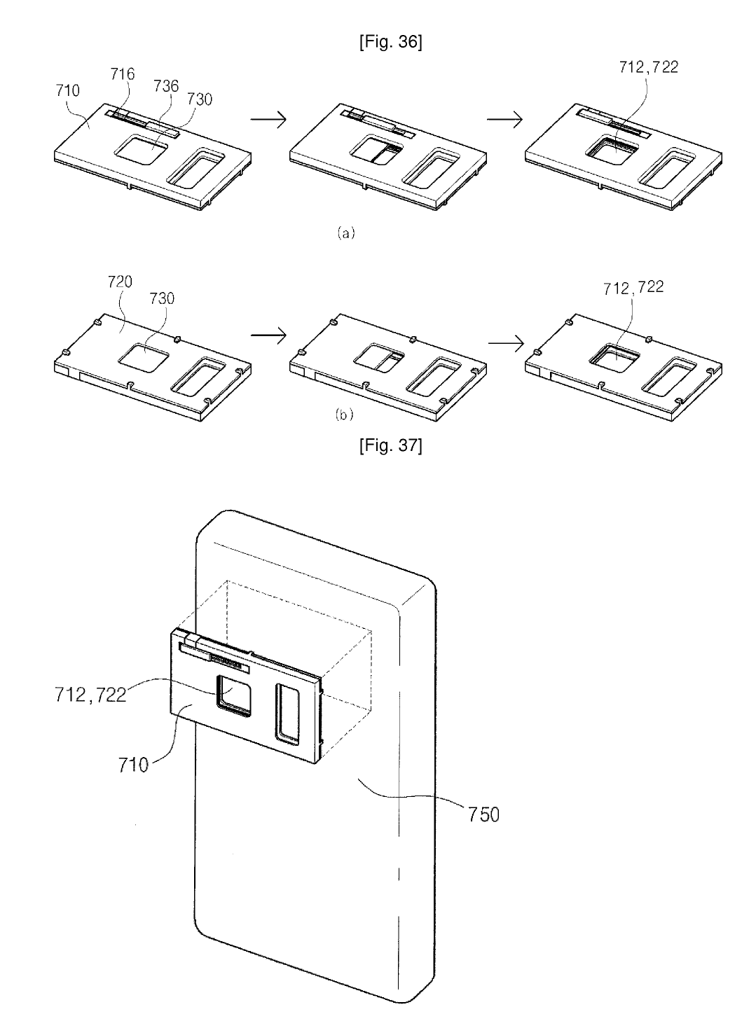

FIGS. 34 and 35 are exploded perspective views of a camera protection apparatus according to the seventh embodiment of the invention. FIG. 36 shows operations of the camera protection apparatus according to the seventh embodiment of the invention.

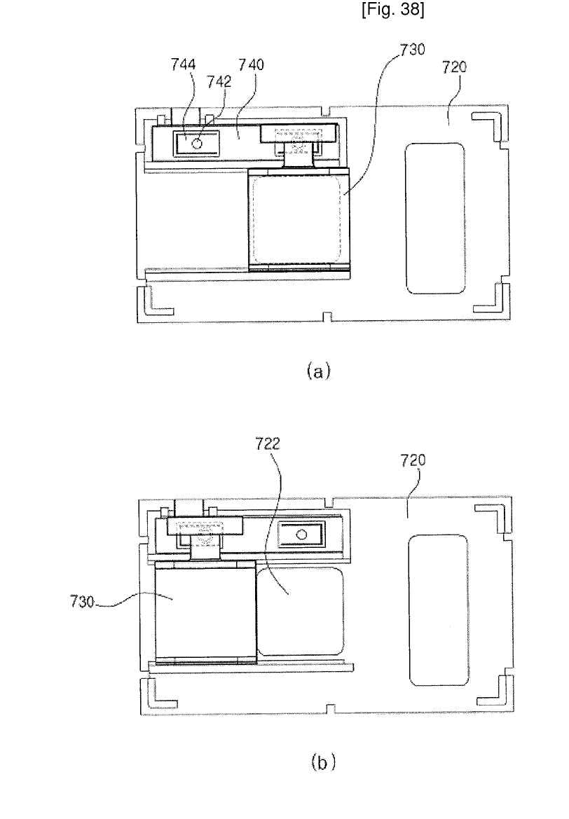

FIG. 37 shows internal operations of FIG. 36. FIG. 38 is a perspective view of the camera protection apparatus when mounted.

Referring to FIGS. 34 to 38, the camera protection apparatus of this embodiment includes a cover member, a blade 730 and a leaf spring 740.

As shown in FIG. 38, the cover member is fixedly installed in a portable terminal 750 where a camera is mounted. The cover member is provided with openings 712 and 722 for shielding and exposing the camera installed in the portable terminal 750.

The cover member is formed to have an internal space in which the blade 730 and the leaf spring 740 are received.

The cover member may be formed of a single piece. Alternatively, for the purpose of easy fabrication and assembling, it is formed of two pieces of members to be combined with each other.

That is, as shown in FIGS. 34 and 36, the cover member is composed of a front cover 710 and a rear cover 720.

The front cover 710 and the rear cover 720 are provided with openings 712 and 722 respectively. The camera mounted on the portable terminal 750 is disposed correspondingly to the openings 712 and 722.

The blade 730 is slidably mounted inside of the cover member so as to open and close the openings 712 and 722. Ultimately, the blade 730 opens and closes the openings 712 and 722 to shield and expose the camera mounted on the portable terminal.

The blade 730 is provided with a lever 736 formed to protrude towards the front cover 710. The front cover 710 is formed with a slot hole 716 through which the lever 736 passes.

As shown in FIG. 36, thus, the blade 730 is configured such that the user can grab and slide the lever 736 along the slot hole 716.

FIGS. 36(a) and 36(b) show the opening operations of the openings 712 and 722 through movement of the 730, seen from the front cover 710 and the rear cover 720 respectively.

Inside of the cover member, i.e., in the internal space, is mounted the leaf spring 740. The leaf spring 740 is mounted on the rear cover 720 of the cover member so as to contact the rear face of the blade 730, i.e., contact the opposite face to the lever 736 formed.

The leaf spring 740 is provided at both sides with a resilient portion 744 formed by cutting off. That is, the resilient portion 744 is formed at both sides of the leaf spring 740 in such a way to cut off in the form of “]” to thereby provide resiliency.

The resilient portion 744 is provided with a protrusion 742 formed to protrude towards the blade 730.

In addition, the blade 730 is provided at the rear face thereof with a receptacle 737 formed correspondingly to the protrusion 742.

Therefore, when the blade 730 slides, the protrusion 742 comes to insert into the receptacle 737.

At this time, the protrusion 742 is generally rounded off, so that it can be easily rested on the receptacle 737 while the blade 730 is sliding.

FIG. 38(a) shows the openings 712 and 722 when closed, and FIG. 38(b) shows them when closed.

As shown in FIG. 37, when the user slides the blade 730 to open or close the openings 712 and 722, he or she can feel clicking of the protrusion 742 into the receptacle 737 and thus easily tell whether the openings 712 and 722 are opened or closed.

Since the camera installed in the portable terminal 750 is opened only when it is to be used, foreign matters are prevented from sticking to the camera lens or entering inside of the camera.

### INDUSTRIAL APPLICABILITY

As described above, the camera protection apparatus according to the invention is installed in a small camera such as cellular phone cameras to open the camera opening when it is to be used, and otherwise to close the camera opening. Thus, foreign matters can be prevented from entering the camera.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

1. A camera protection apparatus for preventing foreign matters from entering a camera, the protection apparatus being installed frontward of the lens of a small camera, the apparatus comprising:
a shield frame being installed frontward of the camera lens and having a sliding space for opening a front side of the lens;
a blade having a protrusion, the blade sliding in the sliding space to open and close the front side of the lens; and
a rotary lever being rotatably coupled with the shield frame, the rotary lever having a central opening formed at the rotational center thereof for opening the front side of the lens, the rotary lever having a cam groove configured so as to be engaged with the protrusion such that rotation of the rotary lever causes the protrusion to move to open and close the blade.

2. The apparatus as claimed in claim 1, wherein the blade includes a pair of blades symmetrically installed, and the protrusion and the cam groove are formed in pairs.

3. The apparatus as claimed in claim 1, wherein one of the shield frame and the rotary lever includes a stopper groove, and the other one thereof includes a guide rib that is engaged with the stopper groove to thereby limit rotation angle of the rotary lever.

4. The apparatus as claimed in claim 1, wherein the rotary lever is provided with a handle protruded to be pushed by a user.

5. The apparatus as claimed in claim 1, further comprising a cover member combined with the shield frame, whereby the cover member is operable to prevent the blade from escaping.

6. A protection apparatus for a small camera, the apparatus comprising:
a cover member fixed to a portable terminal, the cover member having an opening for opening a camera installed in the portable terminal and having an internal space;
a blade slidably installed in the internal space to open and close the opening; and
a slider lever slidably installed in the internal space to move the blade,
wherein the slider lever includes a protrusion, and the blade includes a slant groove configured to be engaged with the protrusion such that when the slider lever performs a linear movement, the protrusion pushes the slant groove such that the blade moves perpendicular to the linear movement of the slider lever.

7. The apparatus as claimed in claim 6, wherein the slider lever includes a guide rib, and the cover member includes a guide groove for guiding the guide rib to perform a linear motion.

8. The apparatus as claimed in claim 6, wherein the slider lever includes a handle protruding outwards of the cover member.

9. The apparatus as claimed in claim 6, wherein one of the slider lever and the cover member includes a stopper protrusion, and the other one of the slider lever and cover member includes:
a depressed portion associated with an initial position of the slider lever, and with which the stopper protrusion is combined; and
a resilient rib associated with a moved position of the slider lever, for elastically grabbing the stopper protrusion.

10. The apparatus as claimed in claim 6, wherein the cover member is fixed to the portable terminal by means of a double-side adhesive tape.

11. A protection apparatus for a small camera, comprising:
a front cover having a first opening for opening a camera installed in a portable terminal;
a blade shaft-supported on the front cover to open and close the first opening through rotational movement thereof;
a rotary lever for rotating the blade by means of rotational movement thereof;
a guide frame for limiting rotational range of the blade and guiding the rotary lever to perform a smooth rotation; and
a rear cover, together with the front cover, protecting both faces of the blade, the rotary lever and the guide frame, the rear cover having a second opening configured correspondingly to the first opening, the rear cover being combined to the portable terminal.

12. The apparatus as claimed in claim 11, wherein the front cover includes a shaft, and the blade includes a rotation hole rotatably engaged with the shaft.

13. The apparatus as claimed in claim 11, wherein the blade includes a pair of blades operating simultaneously in symmetrical directions such that each blade opens and closes half of the first opening.

14. The apparatus as claimed in claim 11, wherein the blade includes a cam protrusion, and wherein the rotary lever includes a cam groove engaged with the cam protrusion such that rotation of the rotary lever is converted into rotation of the blade to thereby open and close the first opening.

15. The apparatus as claimed in claim 11, wherein the rotary lever includes a handle protruding outwards.

16. The apparatus as claimed in claim 11, wherein either one of the front cover and the rear cover includes a connection rib for combining the remaining components.

17. The apparatus as claimed in claim 11, wherein the rear cover is fixed to the portable terminal by means of a double-sided adhesive tape.

18. A camera protection apparatus for a small camera, the apparatus comprising:
a case member having an opening configured to expose a camera installed in a portable terminal, the case member having an internal space and an inner lateral face, the case member having a first retainer groove and a second retainer groove in the inner lateral face;
a blade slidably installed in the internal space to open and close the opening; and
a rotary lever rotating in the internal space to operate the blade in a linear fashion, the rotary lever having a resilient protrusion that is selectively engaged with the first retainer groove or the second retainer groove such that the blade remains resiliently opened or closed.

19. The apparatus as claimed in claim 18, wherein the case member includes a guide face for guiding the blade to perform a smooth linear motion.

20. The apparatus as claimed in claim 18, wherein the blade includes a of a pair of blades that operate simultaneously in symmetrical direction to each open and close half of the opening.

21. The apparatus as claimed in claim 18, wherein the blade includes a cam protrusion, and the rotary lever includes a cam groove that is engaged with the cam protrusion and converts rotation of the rotary lever into linear movement of the blade.

22. The apparatus as claimed in claim 18, wherein the rotary lever includes a handle protruding outwards of the case member.

23. The apparatus as claimed in claim 18, wherein the rotary lever includes a round face, and the case member includes a guide rib that contacts the round face to facilitate rotation of the rotary lever.

24. The apparatus as claimed in claim 18, wherein the case member is fixed to the portable terminal using a double-sided adhesive tape.

25. A protection apparatus for preventing foreign matters from entering a camera installed in a portable terminal, the apparatus being mounted frontward of the camera lens, the apparatus comprising:
a shield plate installed in front of the camera lens and having a first opening for opening a front side of the lens;
a blade slidably opening and closing the first opening, the blade having a cam protrusion;
a rotary plate rotatably combined with the shield plate, the rotary plate having a second opening at the rotational center thereof, the rotary plate having a cam hole configured to be engaged with the cam protrusion such that rotation of the rotary plate causes the cam protrusion to move so as to open and close the blade;
a cover for combining the rotary plate rotatably into the shield plate, the cover having a third opening aligned with the second opening;
a core fixed to either of the shield plate or the rotary plate;
a coil wound around the core to make the core an electromagnet when electric power is applied;
a control unit for supplying electric power to the coil; and
a magnet fixed to either the shield plate or the rotary plate to which the core is not fixed, the magnet generating an electromagnetic field towards the core.

26. The apparatus as claimed in claim 25, wherein the cover includes a guide hole for guiding the cam protrusion to carry out a linear motion.

27. The apparatus as claimed in claim 25, wherein the blade includes a pair of blades installed in symmetrical positions, and the cam protrusion and the cam hole are made in pairs.

28. The apparatus as claimed in claim 25, wherein the magnet is made in pairs which are disposed at both sides of the core respectively.

29. The apparatus as claimed in claim 25, wherein the rotation plate includes a cut-out portion that is movable in both ways with the core placed in-between, and the cut-out portion includes at both end edge areas thereof with an insert hole into which the magnet is inserted.

30. A protection apparatus for a small camera, the apparatus comprising:
a cover member having an internal space, the cover member having an opening configured to shield and expose a camera installed in a portable terminal, the cover member configured to be fixed to the portable terminal;
a blade slidably mounted inside of the cover member so as to open and close the opening; and
a spring disposed in the internal space so as to link the blade and the cover member to each other,
wherein the blade is semi-automatically opened and closed by means of the spring.

31. The apparatus as claimed in claim 30, wherein the spring includes a torsion spring.

32. The apparatus as claimed in claim 30, wherein the spring is mounted so as to be most relaxed when the blade is opened or closed, rather than during movement of the blade.

33. The apparatus as claimed in claim 30, wherein the blade includes a guide protrusion, and the cover member includes a guide hole in the inner side face, into which the guide protrusion is inserted and moves therein.

34. A protection apparatus for a small camera, comprising:
a cover member having an internal space, the cover member having an opening configured to shield and expose a camera installed in a portable terminal, the cover member configured to be fixed to the portable terminal;
a blade slidably mounted inside of the cover member so as to open and close the opening; and
a leaf spring mounted in the inner side of the cover member and contacting a rear face of the blade, the leaf spring having at both sides a protrusion protruding generally towards the blade.

35. The apparatus as claimed in claim 34, wherein the leaf spring includes at both sides thereof a resilient portion formed by cutting-off, and the protrusion is in the resilient portion.

36. The apparatus as claimed in claim 34, wherein the blade includes a receptacle in the rear face thereof so as to correspond to the protrusion.
